(19) United States
(12) Patent Application Publication
(10) Pub. No.: US 2022/0287492 A1
(43) Pub. Date: Sep. 15, 2022

(54) MULTIPURPOSE KITCHEN APPARATUS WITH EXTENDABLE STORAGE

(71) Applicant: Anthony Robert Han Xien Siek, Singapore (SG)

(72) Inventor: Anthony Robert Han Xien Siek, SINGAPORE (SG)

(21) Appl. No.: 17/678,069

(22) Filed: Feb. 23, 2022

Related U.S. Application Data
(60) Provisional application No. 63/161,099, filed on Mar. 15, 2021.

(51) Int. Cl. A47G 23/06; A47J 47/00; A47G 21/14

(52) U.S. Cl. CPC A47G 23/06; A47J 47/005; A47G 21/14

(57) ABSTRACT

A multifunctional kitchen apparatus that may be used for cutting, storing, and serving consumables is disclosed. The apparatus may comprise a rectangle-shaped board under which a pair of flip trays and a pair of removable trays may be placed. The pair of flip trays may be pivotably connected to a front support of the board thereby making it rotatable along a fixed axis. When positioned in a retracted configuration, the pair of flip trays may rest within a first pair of tray slots provided beneath the board. When positioned in an extended configuration, the pair of flip trays may swivel outwards from the side portions of the board and rests parallelly along the front-side portion of the board. Further, the apparatus may comprise of a pair of removable trays capable of being placed within a second pair of tray slots provided beneath the first pair of tray slots.

### CROSS-REFERENCE TO RELATED APPLICATIONS

This application claims benefit of U.S. Provisional Application Ser. No. 63/161,099 entitled “Cutting board with extendable compartments”, filed Mar. 15, 2021, which is incorporated herein in its entirety.

### TECHNICAL FIELD

The present invention relates generally to apparatuses used in catering. More particularly, the present invention is related to a multipurpose kitchen apparatus with extendable compartments primarily used for catering.

### BACKGROUND

Apparatuses used for serving food such as trays have evolved considerably over the years. While conventional serving apparatuses restricted their use cases to merely serving consumables placed on top of them, modern apparatuses provide provisions for ancillary functions such as providing a cutting surface and compartments for holding accessories such as spoons, knives, and the like. Some consumable items such as cheese and meat may require individuals to use tools such as knives for cutting and consuming them. Hence, conventional serving trays may not be adequate for serving and consuming various types of cuisines served in the serving tray.

The utility of food cutting boards are wide and they are used to cater different varieties of delicacies around the world. Hence, innovators across the world are constantly improving the design and utility of such apparatuses. While some are designed to cater to particular varieties of cuisines, others are aimed at solving one or more practical issues faced by individuals using such apparatuses.

U.S. Pat. No. 8,220,789B2 discloses a combination food cutting board including removable cups for food items, and a waste compartment. An upper cutting board mates with a lower base. The upper cutting board includes an aperture aligned with a receptacle in the base for waste, and secondary apertures aligned with matching receptacles in the base for holding the cups food items. The base includes a lateral opening and a sliding drawer in the waste compartment and may include a storage compartment under the upper cutting board.

U.S. Pat. No. 8,286,956B2 discloses a device for preparing food including a stand having a plurality of legs for supporting at least one cutting board and lifting it off a work surface. The cutting board has a hole in it. A pan fits in or underneath the hole to catch juices, scraps or finished cut items cut on the cutting board.

U.S. Ser. No. 10/206,540B2 discloses a cutting board assembly with a rigid planar member, a circular segmented tray member, a plurality of supports, a plurality of non slip feet, a tray turning knob, a rotary bearing assembly and a food retaining curb. The planar member has an aperture matching the perimeter of one segment of the tray member. The tray turning knob is located at the center of the planer member. The rotary bearing assembly is mounted to the underside of the tray. The supports and non slip feet hold the rigid planar member up and prevent it from sliding during use. The food retaining curb is attached to either the left or right side of the rigid planar member, enabling a user to cut items and slide them into one of the tray segments and turn the tray so that a new segment of the tray is available for receiving additional cut items.

U.S. Ser. No. 10/376,104B2 discloses a portable cutting board having a reversible panel mounted with clearance in an opening of a frame for turning movement about a pivot axis between first and second cutting positions. Opposite panel surfaces of the panel are coplanar with opposite sides of the board in each cutting position. The panel is movable to a plurality of tilted positions between the first and second cutting positions. The opposite panel surfaces are tilted in each tilted position.

While the prior arts serve one or more purposes related to this field of art as described above, they do not provide a compact solution that is easy to store or transport. Further an apparatus should preferably be eco-friendly. The present disclosure tries to solve these shortcomings by providing a cutting board assembly that is compact in size but has the capability of being extended and collapsed to modify its utility and capacity. The present disclosure proposes a novel apparatus that addresses the abovementioned shortcomings.

### SUMMARY

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments disclosed herein proposes a multifunctional kitchen apparatus that may be used for cutting, storing, and serving consumables. The proposed apparatus is collapsible thereby making it easy to store and transport. The apparatus comprises of a rectangle-shaped board with a defined thickness. The board includes a top plane, bottom plane, left-side portion, a right-side portion, a front-side portion, and a rear-side portion. The rear-side portion of the board may extend perpendicularly downwards to form a back support for the board. The back support is shaped like a wall and acts as one of the supporting medium for the compartments provided within the apparatus. Further, an inverted T shaped frame extends perpendicularly downwards from the front-side portion to form the front support for the board. A separating pillar may connect the central portion of the back support and the central portion of front support. The front support, the back support and the separating pillar together form a first and second pair of tray slots beneath the bottom plane of the board.

A pair of flip trays (a first flip tray and a second flip tray) may be pivotably connected to the front support of the board. The pair of flip trays may rotate along a fixed axis. When positioned in a retracted configuration, the pair of flip trays may rest within the first pair of tray slots provided beneath the bottom plane of the board. When positioned in an extended configuration, the pair of flip trays rotatably swivels outwards from the side portions of the board and rests parallelly along the front-side portion of the board. Further, the apparatus comprises of a pair of removable trays capable of being inserted into the second pair of tray slots provided beneath the first pair of tray slots when the removable trays are positioned in a retracted configuration. The pair of removable trays may be removed completely out of the second pair of tray slots when the removable trays are positioned in an extended configuration. Furthermore, a top tray may be removably disposed on the top plane of the board.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is an exemplary isometric view of the multipurpose kitchen apparatus in an extended configuration according to the embodiments of the present disclosure;

FIG. 2 is another exemplary isometric view of the multipurpose kitchen apparatus in an extended configuration according to the embodiments of the present disclosure;

FIG. 3 is an exemplary top view of the multipurpose kitchen apparatus without the top tray in an extended configuration depicting the directions in which the flip trays and the removable trays can be displaced according to the embodiments of the present disclosure;

FIG. 4 is an exemplary top rear isometric view of the multipurpose kitchen apparatus in an extended configuration according to the embodiments of the present disclosure;

FIG. 5 is an exemplary front bottom isometric view of the multipurpose kitchen apparatus in an extended configuration according to the embodiments of the present disclosure;

FIG. 6 is a front top isometric view of the multipurpose kitchen apparatus in a retracted/collapsed configuration according to the embodiments of the present disclosure;

FIG. 7 is a front bottom isometric view of the multipurpose kitchen apparatus in a retracted/collapsed configuration according to the embodiments of the present disclosure;

FIG. 8 is a front top isometric view of the rectangle-shaped board of the multipurpose kitchen apparatus according to the embodiments of the present disclosure;

FIG. 9 is a rear top isometric view of the rectangle-shaped board of the multipurpose kitchen apparatus according to the embodiments of the present disclosure;

FIG. 10 is a front bottom isometric view of the rectangle-shaped board of the multipurpose kitchen apparatus according to the embodiments of the present disclosure;

FIGS. 11A and 11B are exemplary illustrations of the first flip tray and the second flip tray respectively of the multipurpose kitchen apparatus according to the embodiments of the present disclosure;

FIG. 12 is an exemplary illustration of a removable tray of the multipurpose kitchen apparatus according to the embodiments of the present disclosure;

FIG. 13 is an exemplary illustration of another removable tray of the multipurpose kitchen apparatus according to the embodiments of the present disclosure;

FIG. 14A is an exemplary illustration of the top view of the top tray and FIG. 14B is an exemplary illustration of the bottom view of the top tray of the multipurpose kitchen apparatus according to the embodiments of the present disclosure;

The drawings described herein are for illustration purposes only and are not intended to limit the scope of the present subject matter in any way.

### DETAILED DESCRIPTION

As discussed in the summary section of the document, the present disclosure proposes a novel multipurpose kitchen apparatus that may be used for cutting, storing, and serving consumables. The apparatus may be compact in size to allow hassle-free storage and transportation. At the same time, the apparatus may be configured with a combination of compartments that may extend the usable surface areas provided by the apparatus during use. When the apparatus is not in use, the compartments may be collapsed inside the slots provided within the body of the apparatus thereby making it compact in size.

According to the embodiments of the present disclosure, the multifunctional kitchen apparatus that may be used for cutting, storing, and serving a wide variety of consumables including solid, semi-solid, and liquid food and drinks. The apparatus may provide a plurality of spaces for serving, cutting, and storing different types of consumables. The apparatus may comprise a rectangle-shaped board with a defined thickness. The thickness of the board allows the board to have one or more depressions of different shapes and sizes for grouping and storing consumables. For example, the board may have circle-shaped depressions that may act as cup-holders on its corners. The size and depth of the depressions allow cups of different shapes and sizes to be securely disposed within the cup-holding contacts of the apparatus.

The apparatus may be commercially referred as a cheese board, cutting board, or charcuterie board. The apparatus may include compartments that are rotatable with respect to a pivot point. The rotatable compartments (flip trays) may be setup in a plurality of configurations to extend the size and capacity of the board depending on its use case. The primary components of the apparatus may be manufactured using bamboo or any other wooden raw material. The specially designed rotatable compartments of the apparatus may be capable of holding tools such as knives, spoons, forks, and the like. Furthermore, other compartments may hold plates and other related tools generally used in catering and serving food. Moreover, there are fixed compartments into which food items such as fruits, peanuts, olives or any other food or snacks may be served. The main body of the apparatus and the rotatable compartments may have complementing dimensions so that the apparatus may be collapsed to its smallest dimensions when not in use and vice versa.

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the ter “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Throughout this document, the term “apparatus”, “multipurpose kitchen apparatus” and “device”, may be used interchangeably while referring to the multipurpose kitchen apparatus as proposed by the present disclosure. Similarly, the terms “rectangle shaped board” and “board” may be used interchangeably while referring to the central board/body of the apparatus disclosed herein. It may be noted that the terms used herein do not restrict the scope of the present subject matter. The terms are used interchangeably depending on the context of the sentence.

The board may have a defined thickness and may include a top plane, bottom plane, left-side portion, a right-side portion, a front-side portion, and a rear-side portion. The side portions, the front portion and the rear portion act as outer frames of the board. The rear-portion of the board may extend perpendicularly downwards up to a defined length to form a back support for the board. The back support may shaped like a wall having a skewed bottom portion that is slightly bent towards the inner portion of the board. The back support may act as one of the supporting medium for the compartments provided within the apparatus. The rear-side portion of the board along with the extended portion (wall) together maybe referred to as the back support.

Furthermore, an inverted T shaped frame extends perpendicularly downwards from the front-side portion to form the front support for the board. The height of the inverted T shaped frame may equal the height of the back support. The horizontal portion of the inverted T shaped frame may be positioned parallel to the front-side portion of the board. The front-side portion and the inverted T shaped frame together maybe referred to as the front support of the apparatus. A separating pillar may connect the central portion of the back support and the central portion of front support. The front support, the back support and the separating pillar together form a first and second pair of tray slots beneath the bottom plane of the board. The first pair of tray slots are positioned directly below the bottom plane of the board while the second pair of tray slots are positioned just below the first pair of tray slots. The first pair tray slots may be separated by the supporting pillar. Similarly, the second pair of tray slots positioned just below the first pair of tray slots may be separated by the supporting pillar.

The first and second pair of tray slots act as compartments into which the trays of different configurations may be placed. The apparatus may comprise a pair of flip trays, a pair of removable trays and a top tray. The pair of flip trays (a first flip tray and a second flip tray) may be pivotably connected to the front support of the board. The pair of flip trays may rotate along a fixed axis with respect to the pivot point. When positioned in a retracted configuration, the pair of flip trays may rest within the first pair of tray slots provided beneath the bottom plane of the board. When positioned in an extended configuration, the pair of flip trays may swivel (in an angular motion) outwards from the side portions of the board and may rest parallelly along the front-side portion of the board. The pair of flip trays basically extend the surface area of the apparatus near its front portion.

Further, the apparatus may comprise of a pair of removable trays capable of being inserted into the second pair of tray slots located just beneath the first pair of tray slots. The pair of removable trays may rest within the second pair of tray slots when the removable trays are positioned in a retracted configuration. The pair of removable trays may be removed completely out of the second pair of tray slots when the removable trays are positioned in an extended configuration. The removable tray may be pulled out from the slot for use and may be pushed back into the slot when not in use.

Furthermore, an optional top tray may be removably disposed on the top plane of the board. The top tray may be placed directly above the top plane of the board that has a cutting board at its central portion. When the cutting board is not required, the top tray may be placed on top of the board. The top tray may be completely removed from the top plane of the board when it is not required.

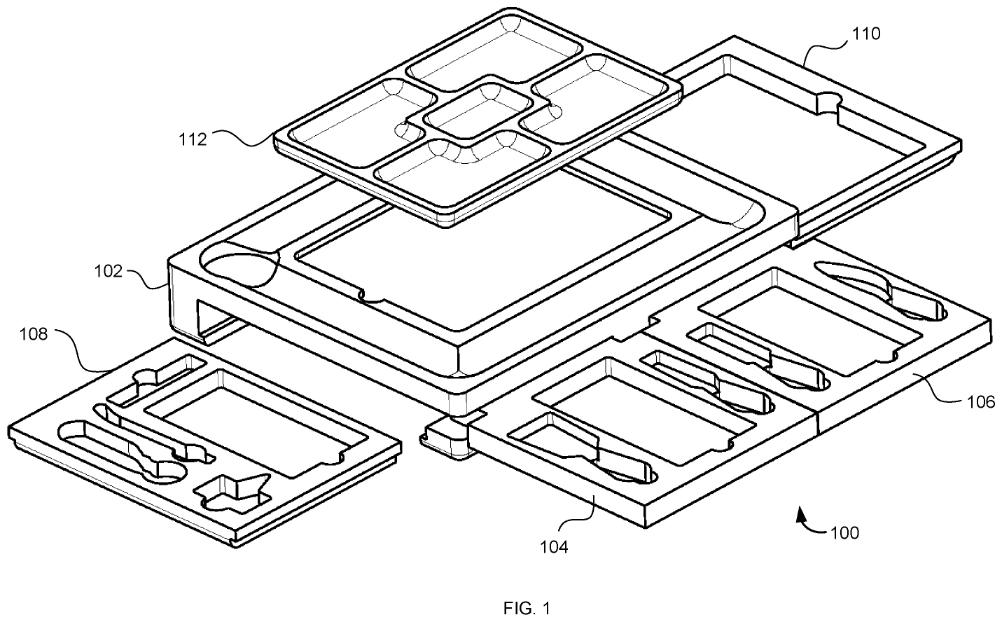

Referring to the figures, FIG. 1 is an exemplary isometric view of the multipurpose kitchen apparatus in an extended configuration according to the embodiments of the present disclosure. The apparatus 100 comprises of a rectangle shaped board 102, a first flip tray 104 and a second flip tray 106 (together referred to as the pair of flip trays), a first removable tray 108 and a second removable tray 110 (together referred to as the pair of removable trays), and a top tray 112. The figure depicts the entire apparatus and its components in a extended configuration in top left front isometric view.

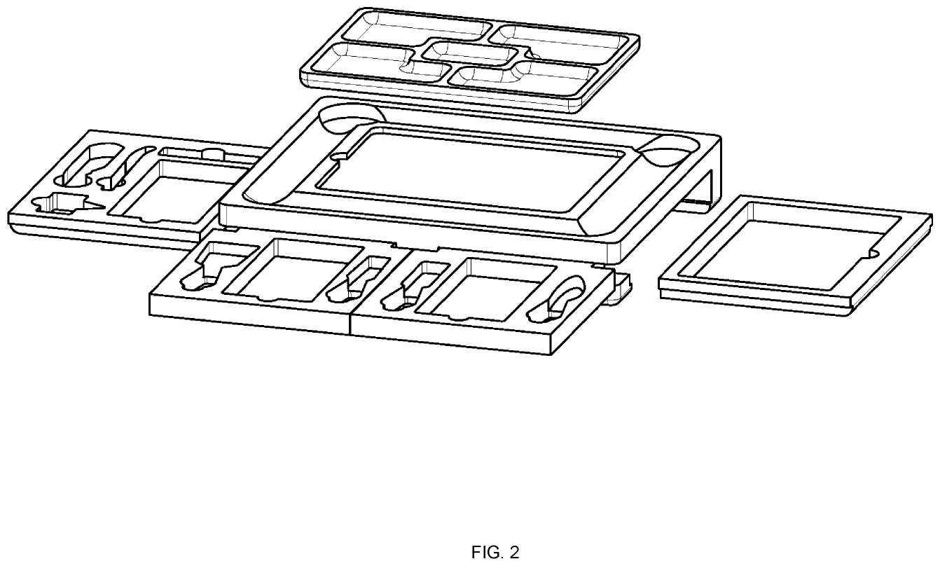

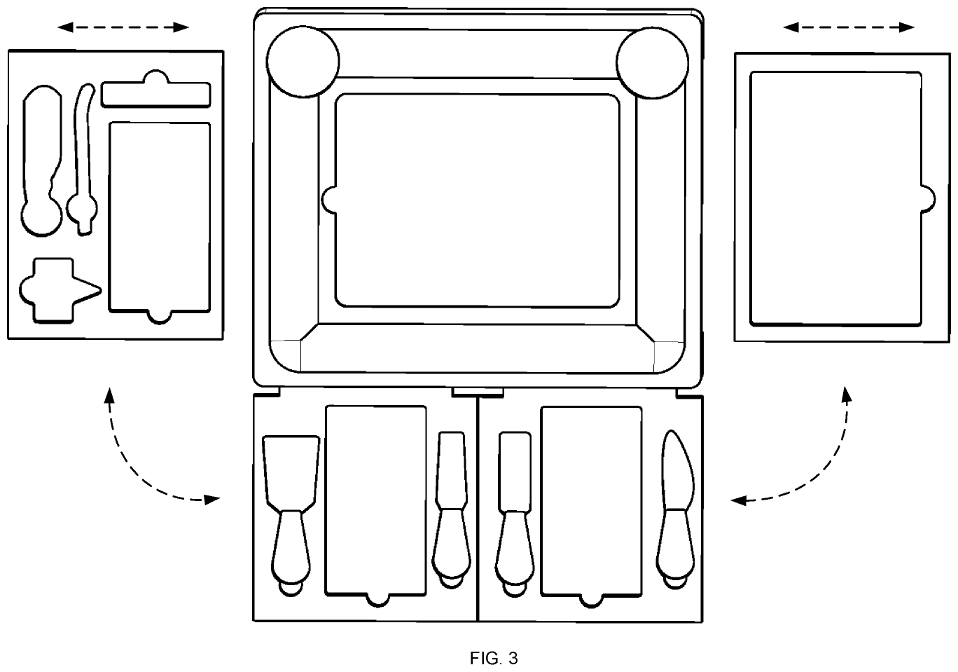

FIG. 2 is another exemplary isometric view of the multipurpose kitchen apparatus 100 in an extended configuration in top right front isometric view according to the embodiments of the present disclosure. FIG. 3 is an exemplary top view of the multipurpose kitchen apparatus without the top tray in an extended configuration depicting the directions in which the flip trays and the removable trays can be displaced according to the embodiments of the present disclosure. The pair of flip trays 104 and 106 may be swivelled in and out of the first pair of slots provided beneath the bottom plane of the board 102. The direction of angular rotation is depicted by dotted curved lines with arrows on both heads. The trays rotate along an angle of 180 degrees beyond which the motion is restricted either by the supporting pillar of by the other flip tray as depicted in the figures and as understood by a person skilled in the art. Similarly the movement of the first and second removable trays 108 and 110 are depicted using straight dashed lines with arrow heads on both ends depicting the direction of movement of the removable trays. The removable trays may be pushed into the second pair of slots provided under the bottom plane of the board 102 when the apparatus is in a retracted configuration. The removable trays may be pulled out from the second pair of slots when the apparatus is in an extended configuration.

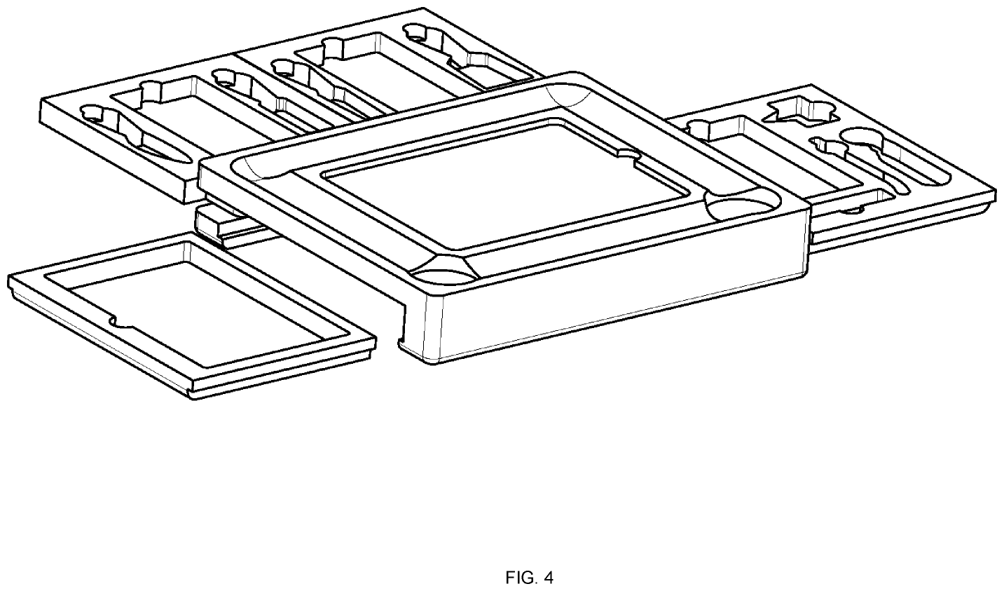

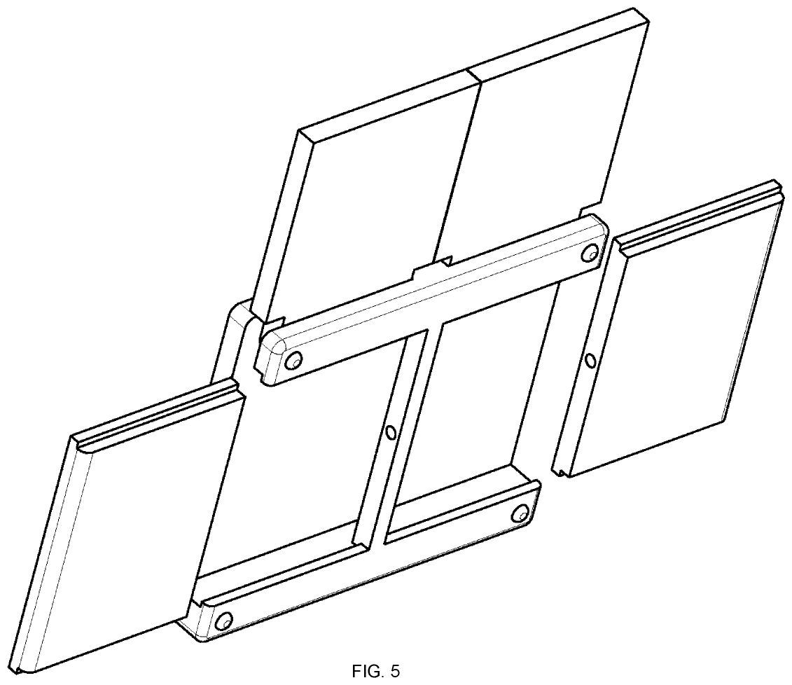

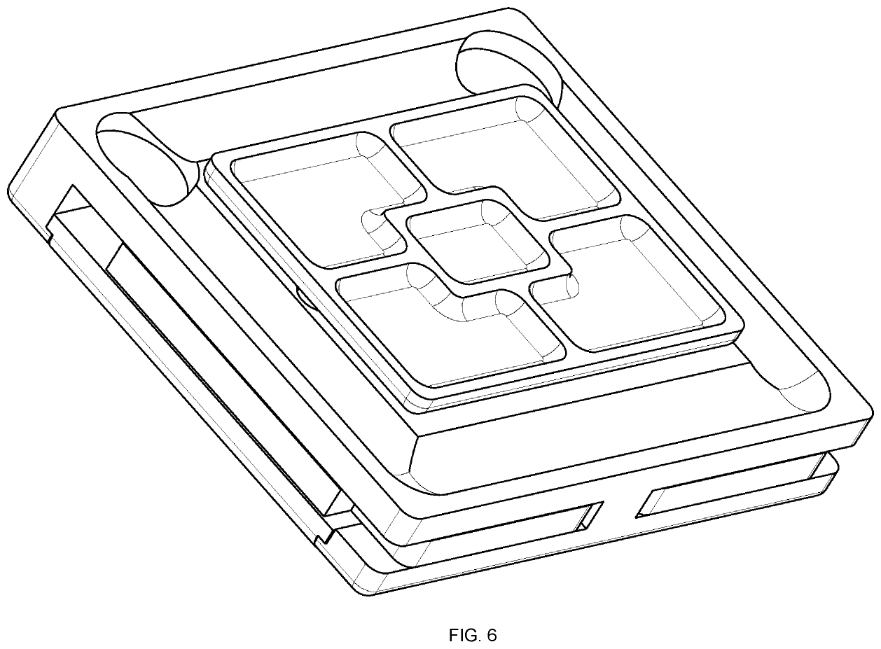

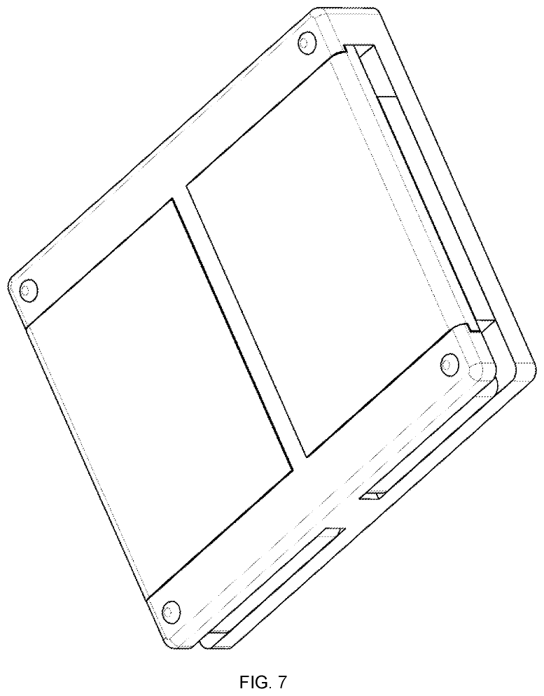

FIG. 4 is an exemplary top rear isometric view of the multipurpose kitchen apparatus without the top tray 112 in an extended configuration according to the embodiments of the present disclosure. FIG. 5 is an exemplary front bottom isometric view of the multipurpose kitchen apparatus in an extended configuration according to the embodiments of the present disclosure. FIG. 6 is a top left front isometric view of the multipurpose kitchen apparatus in a retracted/collapsed configuration according to the embodiments of the present disclosure. Herein, all the trays are positioned in their compartments. The apparatus may be easily transported or stored in this configuration since the apparatus is compact and occupies less space. FIG. 7 is a front bottom isometric view of the multipurpose kitchen apparatus in a retracted/collapsed configuration according to the embodiments of the present disclosure.

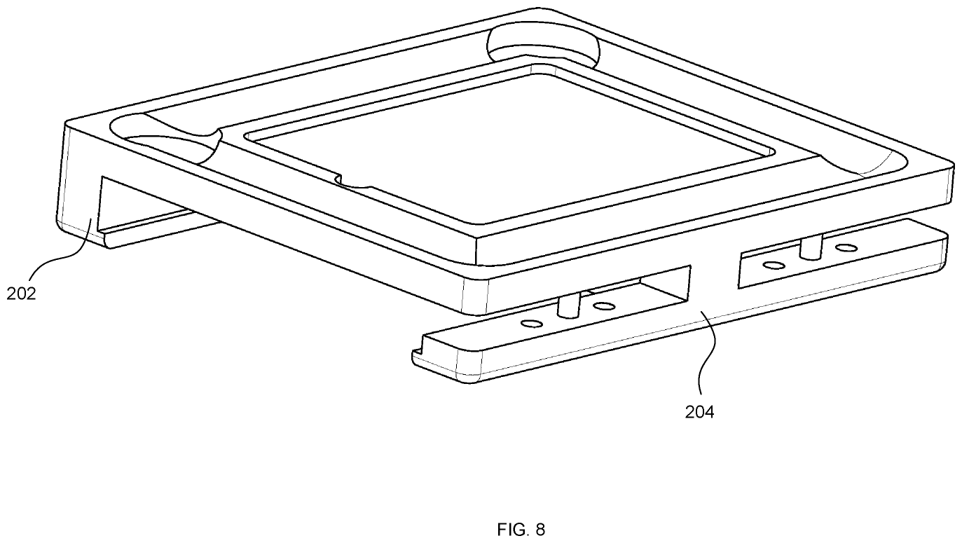

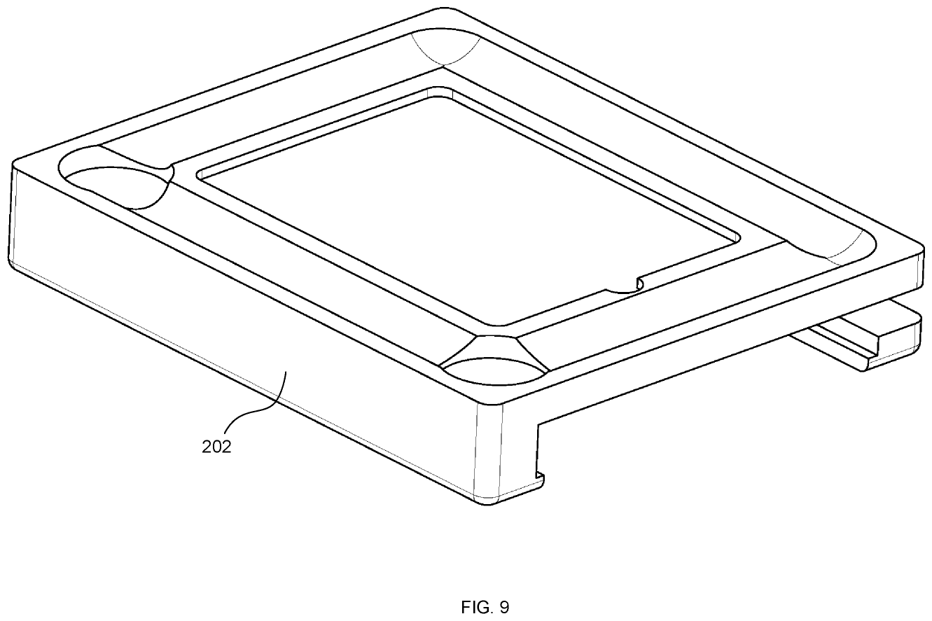

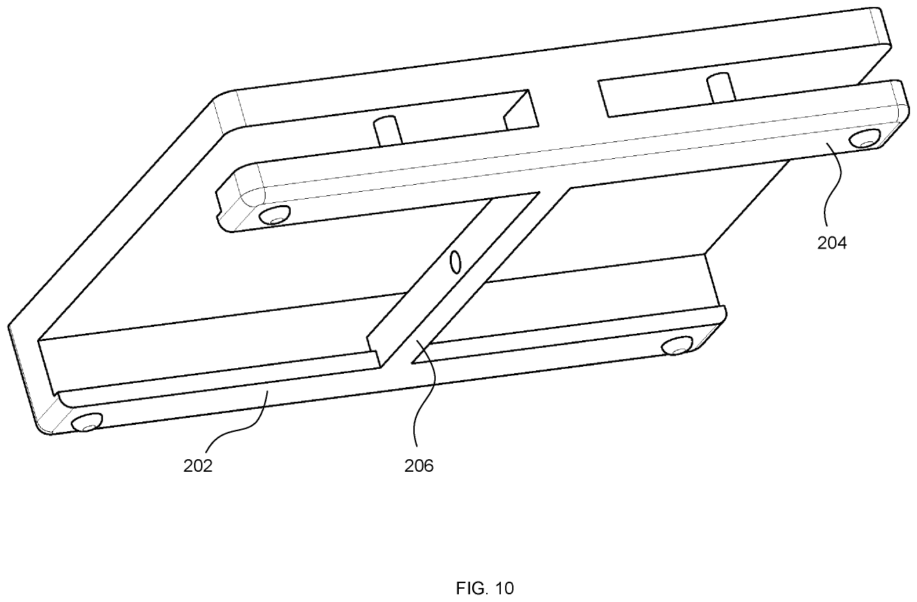

FIG. 8 is a front top isometric view of the rectangle-shaped board 102 of the multipurpose kitchen apparatus according to the embodiments of the present disclosure. FIG. 9 is a rear top isometric view of the rectangle-shaped board 102 of the multipurpose kitchen apparatus according to the embodiments of the present disclosure. FIG. 10 is a front bottom isometric view of the rectangle-shaped board 102 of the multipurpose kitchen apparatus according to the embodiments of the present disclosure. The back support 202, the front support 204, and the supporting pillar 206 together form compartments for storing the trays.

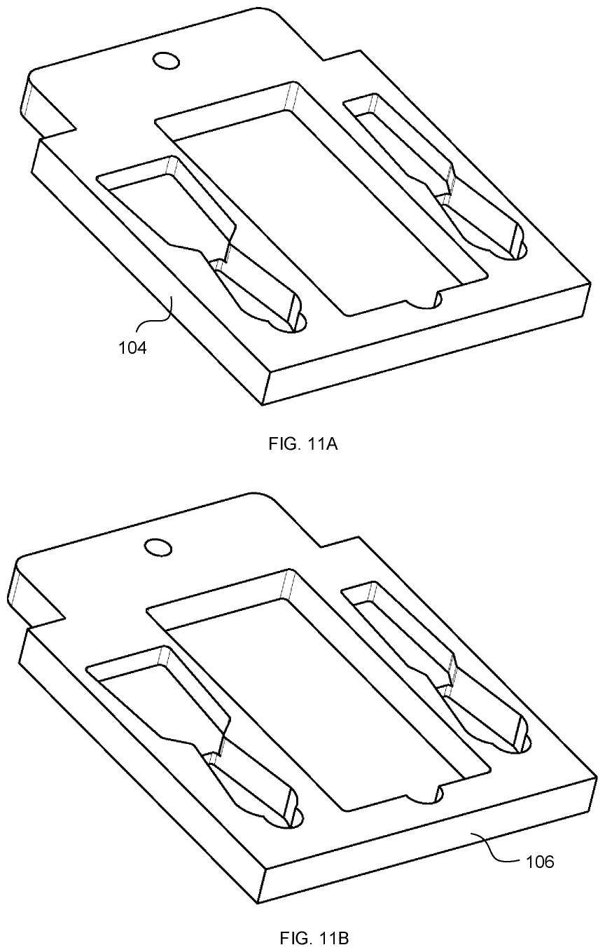

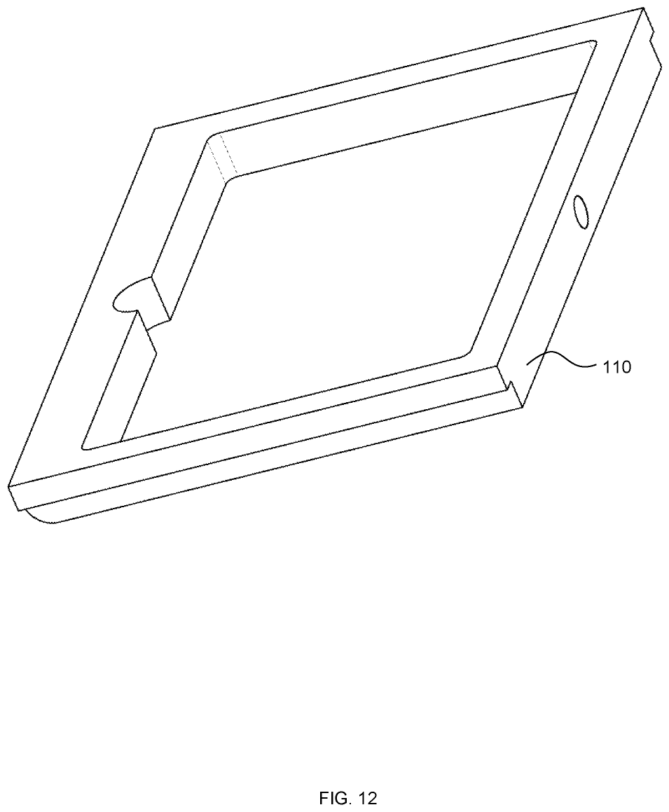

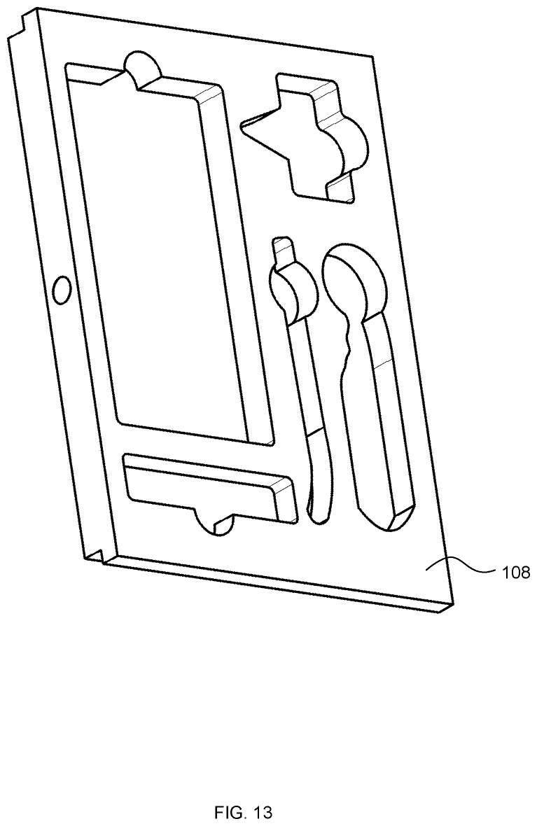

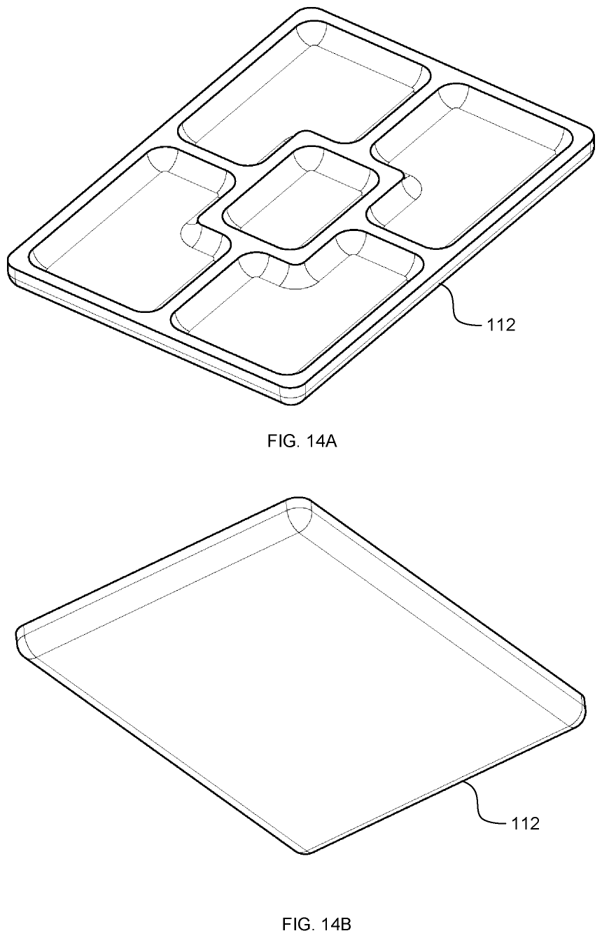

FIGS. 11A and 11B are exemplary illustrations of the first flip tray 104 and the second flip tray 106 respectively of the multipurpose kitchen apparatus 100 according to the embodiments of the present disclosure. FIG. 12 is an exemplary illustration of the first removable tray 108 of the multipurpose kitchen apparatus according to the embodiments of the present disclosure. FIG. 13 is an exemplary illustration of the second removable tray 110 of the multipurpose kitchen apparatus according to the embodiments of the present disclosure. FIG. 14A is an exemplary illustration of the top isometric view of the top tray 112 and FIG. 14B is an exemplary illustration of the bottom isometric view of the top tray 112 of the multipurpose kitchen apparatus 100 according to the embodiments of the present disclosure.

The compartments (the first pair of tray slots and the second pair of tray slots) may host the pair of flip trays and the pair of removable trays when the apparatus is collapsed for storage. The top plane of the board comprises a cutting board at the central portion, cup holders at the corners, and spaces for storing or serving consumables. The first and second flip trays, the pair of removable trays, and the top tray comprises a combination of storage slots for storing cutlery and spaces of storing or serving consumables. The cutlery stored in the storage slots include spoons, forks, knives, chopsticks, strainers, spatula, graters, tongs, and the like.

The first and the second flip trays swivels through an angle of 180 degrees when alternated between retracted and extended configurations. The separating pillar and body of the second flip tray may act as stoppers for restricting the angular movement of the first flip tray. Similarly, the separating pillar and body of the first flip tray may act as stoppers for restricting the angular movement of the second flip tray. The first and second flip trays are pivotably connected to a pair of sockets provided on the front support of the board.

The components of the apparatus including the board, the pair of flip trays, the pair of removable trays, and the top tray may be manufactured using materials including bamboo, natural wood, plywood, plastic, fiber, silicon, ceramic, polymer-based materials etc. Alternatively, any other compatible wood or non-wood raw material may also be used to suit the needs of the end-user.

The cutting board may have a quadrilateral-shaped body (preferably, rectangle shape) with the top surface having a plurality of pockets to hold a plurality of food items along with one or more serving tools. The pockets may be engraved into the body of the apparatus with each pocket designed to hold one or more food items or containers. In one example, one or more beverage holders or cup holders may be provided on the top surface of the cutting board.

The pair of flip trays 104 and 106 may be disposed on either side of this supporting pillar 206. The pivot points that connect the flip trays to the front support may be located at a point equidistant from the side portion of the board and the supporting pillar so that the flip trays will be able to make a 180 degree turn.

The pockets provided on the main body and the different compartments may be provided with tools/accessories such as spoons, knives, spreaders, plates, containers such as beverage holders, bowls, and other related tools as understood by a person skilled in the art. The primary advantage of the present invention include the hassle-free expanding/contracting functionality provided by the extendable and rotatable compartments of the apparatus. The configuration of the apparatus may be varied by means of providing different types of compartments depending upon the cuisines served on the cutting board. The apparatus may be easily collapsed and fixed with minimal compartments depending upon the use case.

Another notable advantage of the collapsible nature of the compartments is that it allows users to easily clean the apparatus after usage. In one example, one or more plates (such as ceramic plates) may be placed in one of the compartments. User may be able to use these plates while placing them in the compartments or may be able to remove these plates to use them separately depending upon the use case.

The proposed cutting board efficiently uses the available space by taking maximum advantage of the pivot points and the design of the rotatable flip trays. Herein, the rear side of the flip trays that pivotably connect to front support of the board may have lesser width compared to other portions of the flip trays so as to avoid friction/contact between the flip trays during rotational movement as understood by a person skilled in the art. This design makes it possible for the rotating compartments to align seamlessly when completely extended without causing any gap. Moreover, this design allows the combination of rotating compartments to have the same width as that of the main body. In FIGS. 11A and 11B, it may be noted that the portion having the pivot point that connects the flip trays 104 and 106 to the board 102 body may have a smaller width compared to the rest of its body. This design makes sure that the supporting pillar 206 doesn't affect the surface area provided by the apparatus in a fully extended configuration. This is demonstrated more particularly in FIG. 3 wherein flip trays 104 and 106 when extended fully have a combined width equal to the width of the board 102. Moreover, this design makes it possible for extending both the rotating compartments and placing them side-by-side without any gaps in between as illustrated in the figures.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A multifunctional kitchen apparatus, comprising:
a rectangle-shaped board with a defined thickness having a top plane, bottom plane, left-side portion, a right-side portion, a front-side portion, and a rear-side portion, the rear-side portion extending perpendicularly downwards to form a back support for the board, an inverted T shaped frame extending perpendicularly downwards from the front-side portion to form the front support for the board, a separating pillar connecting the central portion of the back support and the central portion of front support, wherein the front support, the back support and the separating pillar form a first and second pair of tray slots beneath the bottom plane of the board;
a first flip tray and a second flip tray pivotably connected to the front support of the board, wherein the first and second flip trays rotate along a fixed axis, the first and second flip trays rest within the first pair of tray slots provided beneath the bottom plane of the board when the first and second flip trays are positioned in a retracted configuration and swivels outwards from the side portions of the board and rests parallelly along the front-side portion of the board when the first and second flip trays are positioned in an extended configuration;
a pair of removable trays capable of being inserted into the second pair of tray slots provided beneath the first pair of tray slots when the removable trays are positioned in a retracted configuration and removed completely out of the second pair of tray slots when the removable trays are positioned in an extended configuration; and
a top tray removably disposed on the top plane of the board.

2. The apparatus of claim 1, wherein the top plane of the board comprises a cutting board at the central portion, cup holders at the corners, and spaces for storing or serving consumables.

3. The apparatus of claim 1, wherein the first and second flip trays, the pair of removable trays, and the top tray comprise a combination of storage slots for storing cutlery and spaces of storing or serving consumables.

4. The apparatus of claim 3, wherein the cutlery stored in the storage slots include spoons, forks, knives, chopsticks, strainers, spatula, graters, and tongs.

5. The apparatus of claim 1, wherein the first and the second flip trays swivels through an angle of 180 degrees when alternated between retracted and extended configurations.

6. The apparatus of claim 5, wherein the separating pillar and body of the second flip tray act as stoppers for restricting the angular movement of the first flip tray.

7. The apparatus of claim 5, wherein the separating pillar and body of the first flip tray act as stoppers for restricting the angular movement of the second flip tray.

8. The apparatus of claim 1, wherein the board, the pair of flip trays, the pair of removable trays, and the top tray are manufactured using bamboo, natural wood, plywood, ceramic, or plastic.

9. The apparatus of claim 1, wherein the first and second flip trays are pivotably connected to a pair of sockets provided on the front support of the board.
